(19) United States
(12) Patent Application Publication
(10) Pub. No.: US 2026/0211644 A1
(43) Pub. Date: Jul. 23, 2026

(54) DYNAMIC CALLBACK SERVICES FOR RAP BASED REUSE SERVICES

(71) Applicant: SAP SE, Walldorf (DE)

(72) Inventors: Wolfgang WALTER, Heidelberg (DE); Renzo COLLE, Stutensee (IT)

(21) Appl. No.: 19/049,529

(22) Filed: Feb. 10, 2025

Related U.S. Application Data
(60) Provisional application No. 63/746,396, filed on Jan. 17, 2025.

(51) Int. Cl. G06F 8/36; G06F 8/30

(52) U.S. Cl. CPC G06F 8/36; G06F 8/315

(57) ABSTRACT

Systems and methods include reception of a request to modify an instance of a reuse component and, in response to the request, determine an interface entity of the reuse component and a property of the reuse component which stores an identifier of a host object instance of the reuse component instance, call a first predefined operation with the type of the host object and an identifier of the host object instance to set a lock on the host object instance, create a data container of key field values of the host object instance based on data types of the key fields, and call a second predefined operation with the type of the host object and the data container to check an authorization to modify the host object instance.

### CROSS-REFERENCE TO RELATED APPLICATIONS

This application claims priority to, and benefit of, U.S. Provisional Ser. No. 63/746,396 , filed Jan. 17, 2025, the contents of which are incorporated by reference herein for all purposes.

### BACKGROUND

Software applications are ubiquitous in the operations of modern organizations. An organization may use many different software applications, which include off-the-shelf applications, customized applications, and/or applications developed specifically for the organization. These software applications may be executed by user devices, on-premise servers, and/or cloud-based servers.

Many software applications are designed based on object-oriented programming principles. The data and functionality of such software applications are organized and structured with respect to objects. Objects of a software application and their classes may be defined by an application developer and, in some cases, by a third-party developer or a customer organization.

Objects are self-contained entities that encapsulate data and behavior, and are modeled to represent real-world entities or concepts. Objects are implemented using classes which define attributes of an object's data and methods which provide an object's behavior. Examples of objects include but are not limited to Customer, SalesOrder, Supplier, PurchaseOrder. Object instances represent specific occurrences of an object, such as Customer Jane Doe, SalesOrder 4711, etc.

An application developer may provide reuse components which may be called by any object of a software application to access functionality provided thereby. A reuse component may consist of backend and frontend functionality (e.g., logic and a UI component). Examples of reuse objects include an Attachment reuse component which provides a UI component for dragging a file (e.g., a PPT file) to an object instance (e.g., Salesorder 4711) and logic for linking the file to the object instance (now referred to as a host object instance) in the backend.

Reuse components should be loosely coupled to their host objects. However, if an instance of a reuse component (e.g., a particular file linked to a particular Sales Order instance) is to be modified, the reuse component must determine whether the modification is allowed from the perspective of the host object instance. The determination includes checking whether the host object instance is locked, whether the user has the authorization required to perform the modification, and whether the state of the host object instance allows changes to its reuse component (e.g., is the host object instance archived and therefore unmodifiable?).

To maintain loose coupling between a reuse component and its host objects, these checks are conventionally implemented via decoupled callbacks. In particular, a reuse component specifies interfaces defining Lock, Check Authorization and Check Feature Control methods. Any host object which intends to use a reuse component must include a class which implements each interface to perform the corresponding check.

FIG. 1A illustrates reuse component A and its Lock, Check Authorization and Check Feature Control interface definitions (labeled “DefinitionA”). In order to use reuse component A (i.e., in order for its instances to use instances of reuse component A), host object 1 includes classes (labeled “Class1A”) for implementing each interface. Similarly, in order to use reuse component A, host object 2 includes other classes (labeled “Class2A”) for implementing each interface. Each Class1A for a given DefinitionA likely differs from the Class2A for the same DefinitionA.

Turning to FIG. 1B, reuse component B includes its own Lock, Check Authorization and Check Feature Control interface definitions (labeled “DefinitionB”). In order to use reuse component B, host object 1 includes classes (labeled “Class1B”) for implementing each interface. Host object 3 includes classes (labeled “Class3B”) for implementing each interface of reuse component B. Class1B for a given DefinitionB likely differs from Class1A for the given DefinitionA, and Class3B for a given DefinitionB likely differs from Class1B for the given DefinitionB.

Accordingly, the number of implementations required for a reuse component is equal to three times the number of host objects which intend to use the reuse component. This amount of coding requires significant time and expense. Moreover, an organization which desires to implement a new host object in an existing software application may lack the expertise to code the required interface implementations.

Systems are desired to efficiently reduce development efforts for adopting reuse components, and to support code-free adoption thereof.

### BRIEF DESCRIPTION OF THE DRAWINGS

FIGS. 1A and 1B illustrate reuse component enhancement definitions and corresponding host object enhancement implementations.

FIG. 2 is a user interface of a host object including a user interface of a reuse component according to some embodiments.

FIG. 3 is a sequence diagram of host object instance checks initiated by a reuse component according to some embodiments.

FIG. 4 is a block diagram of reuse components and fallback enhancement implementations utilizing dynamic host callbacks according to some embodiments.

FIG. 5 illustrates metadata of an object type definition specifying a behavior implementation according to some embodiments.

FIG. 6 illustrates metadata modelling associations of an object type according to some embodiments.

FIG. 7 illustrates metadata modelling associations of an object type according to some embodiments.

FIGS. 8A-8C comprise a flow diagram of a process to execute a fallback enhancement implementation utilizing dynamic host callbacks according to some embodiments.

FIG. 9 is a block diagram of a computing system implementing reuse components and fallback enhancement implementations according to some embodiments.

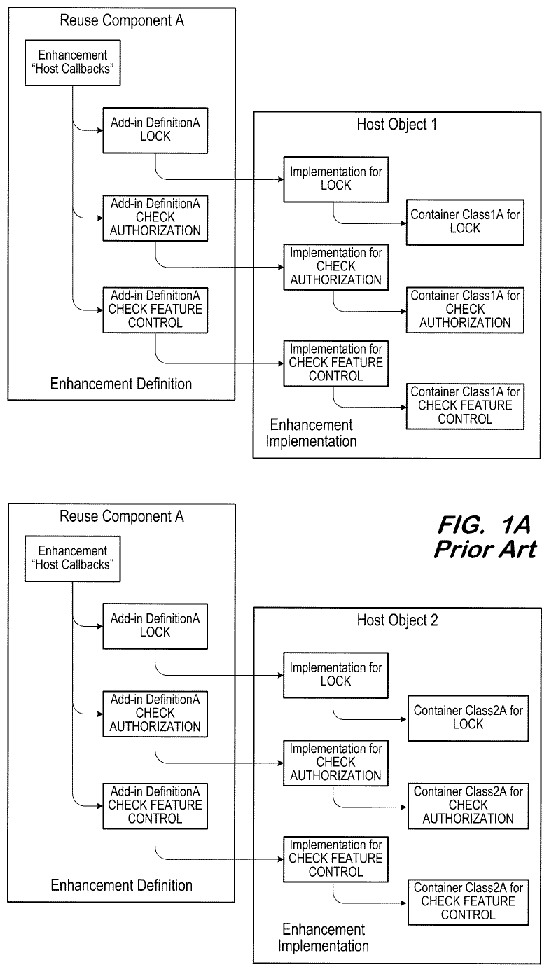

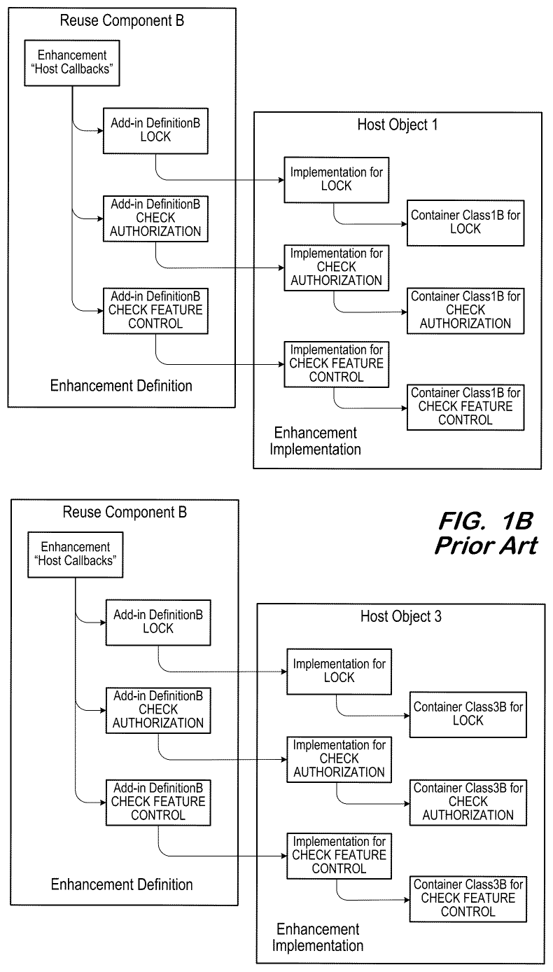

### DETAILED DESCRIPTION

The following description is provided to enable any person in the art to make and use the described embodiments and sets forth the best mode contemplated for carrying out some embodiments. Various modifications, however, will be readily-apparent to those in the art.

According to some embodiments, a reuse component includes fallback implementations for interfaces defining the above-mentioned Lock, Check Authorization and Check Feature Control methods. The implementations provide dynamic host callbacks by leveraging host object metadata from a central repository to dynamically populate parameters of runtime APIs with object-appropriate metadata. Embodiments may therefore generate calls to lock or to check instance authorization of any host object instance in the system without requiring reuse component-specific coding of the host object. Consequently, it is only required to code three interface implementations for each reuse component of a system, regardless of the number of host objects which use each reuse component.

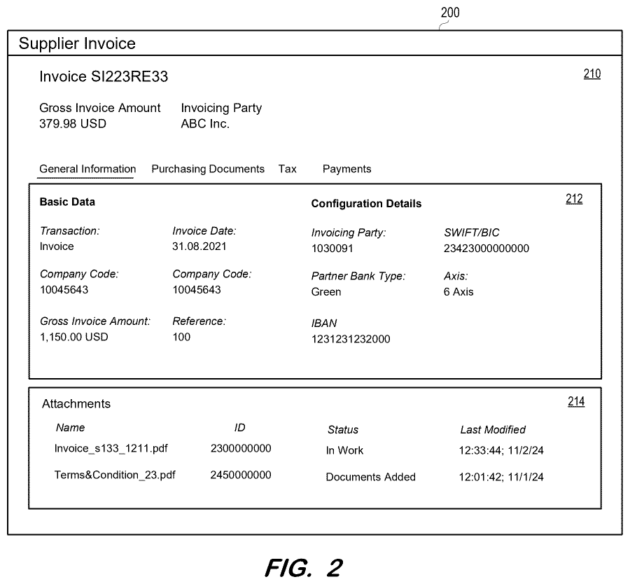

FIG. 2 shows user interface (UI) 200 of a host object SupplierInvoice including a user according to some embodiments. UI 200 may be displayed by a Web browser executing a front-end user interface application corresponding to a backend application. In one example, a user executes a Web browser to access the backend application via HyperText Transfer Protocol and receives UI 200 in return.

UI 200 includes UI components 210 and 212 which may be specific to and provided by a SupplierInvoice host object. UI components 210 and 212 present data associated with a particular instance of the SupplierInvoice host object (i.e., Invoice SI223RE33). UI 200 also includes UI component 214 which is provided by an Attachments reuse component according to some embodiments. The Attachments reuse component may provide logic for attaching a file to a host object instance.

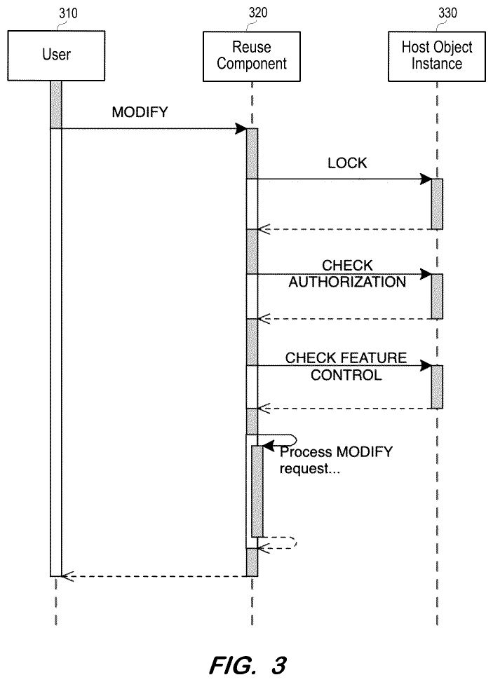

A user may manipulate UI component 214 to instruct modification of one of the attachments to the host object instance. As described above, prior to performing the modification, the reuse component must check whether its host object instance is locked, whether the user has the authorization required to perform the modification to the host object instance, and whether the state of the host object instance allows changes to its Attachment reuse component. FIG. 3 is a sequence diagram of host object instance checks initiated by a reuse component in response to an instruction to modify the reuse component according to some embodiments.

As shown, user 310 provides a request to modify reuse component 320. In response, reuse component 320 generates and passes a callback to lock host object instance 330. If the lock is successful, reuse component 320 generates and passes a callback to host object instance 330 to check the user's authorization to modify instance 330. Next, if the user has authorization to modify instance 330, reuse component 320 generates and passes a callback to host object instance 330 to check whether the modification is permitted. If modification is permitted, reuse component 320 executes to process the modification request. Processing of the modification request may include execution of locks and permission checks by reuse component 320.

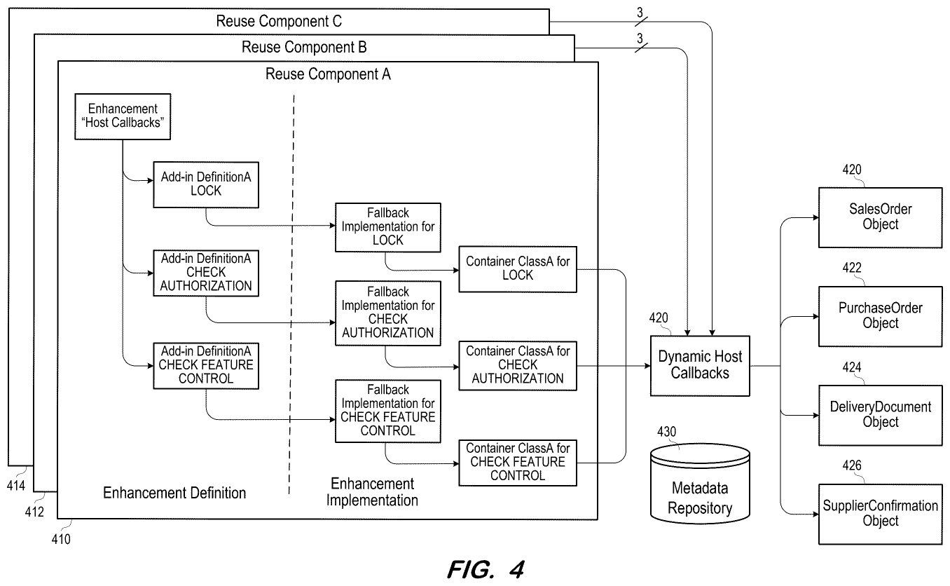

FIG. 4 is a block diagram of reuse components and fallback enhancement implementations utilizing dynamic host callbacks according to some embodiments. Reuse component A 410 includes Lock, Check Authorization and Check Feature Control interface definitions (labeled “DefinitionA”). Reuse component A 410 also includes classes (labeled “ClassA”) providing fallback implementations of each interface. Each fallback implementation is capable of populating parameters of dynamic host callbacks 420 with corresponding metadata from metadata repository 430 to perform checks of instances of any of host objects 420-426.

Reuse component B 412 and reuse component C 414 also include their own Lock, Check Authorization and Check Feature Control interface definitions, and classes providing fallback implementations of each interface. These fallback implementations may also populate dynamic host callbacks 420 with metadata from metadata repository 430 to perform checks of instances of any of host objects 420-426. The implementations provided by reuse component A 410, reuse component B 412, and reuse component C 414 are referred to herein as “fallback” implementations because any host object may also provide its own implementations of the Lock, Check Authorization and Check Feature Control interfaces. If a host object provides such implementations, those implementations are executed instead of the fallback implementations during the sequence depicted in FIG. 3.

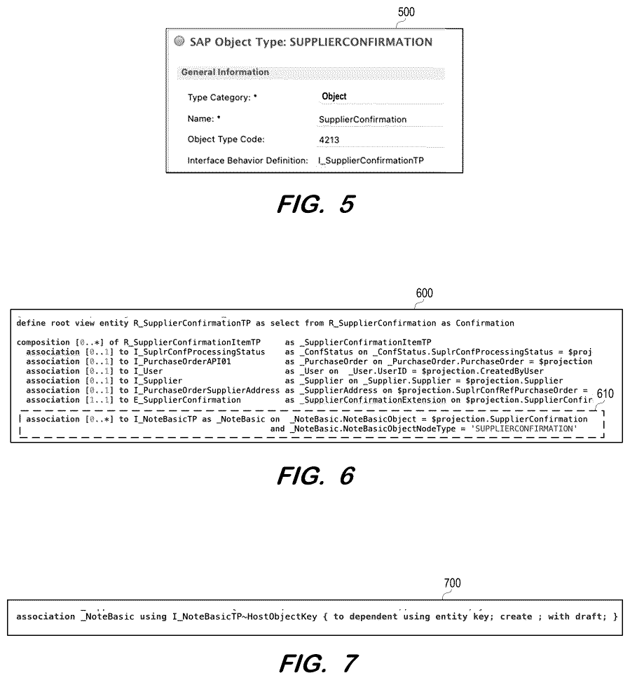

Embodiments require storage of particular metadata for a host object in metadata repository 430 in order to generate callbacks for checking instances of the host object using fallback implementations as described herein. For example, FIG. 5 illustrates metadata of object type definition 500 according to some embodiments. A repository such as metadata repository 430 may store an object type definition for each object within an application system. Object type definition 500 specifies a behavior implementation “I_SupplierConfirmationTP” for the host object SupplierConfirmation.

FIG. 6 illustrates metadata 600 associated with a SupplierConfirmation object type according to some embodiments. In some embodiments, each object type is modeled by metadata representing database tables, views, or structures. The metadata may also define annotations, elements (e.g., columns/fields), associations (e.g., relationships between entities), and logic (e.g., calculated fields or aggregations). Metadata 610 models the association of the SupplierConfirmation object type to the reuse component NoteBasic. As will be described below, the fallback implementations evaluate the JOIN condition of metadata 610 to identify certain host properties.

FIG. 7 illustrates metadata 700 modelling associations for an object type according to some embodiments. Metadata 700 may be stored in a repository which models the transactional runtime. Metadata 700 indicates whether associations between the object type and the reuse component are based on the entity key (e.g., the database key) of the object type, or whether a key conversion is required. According to the FIG. 7 example (i.e., “using entity key”), no key conversion is needed. If a key conversion were needed (e.g., if metadata 700 included “using own key ‘abc’”), metadata 700 would include a definition of an alternative key and a conversion function for converting alternative keys to object entity keys.

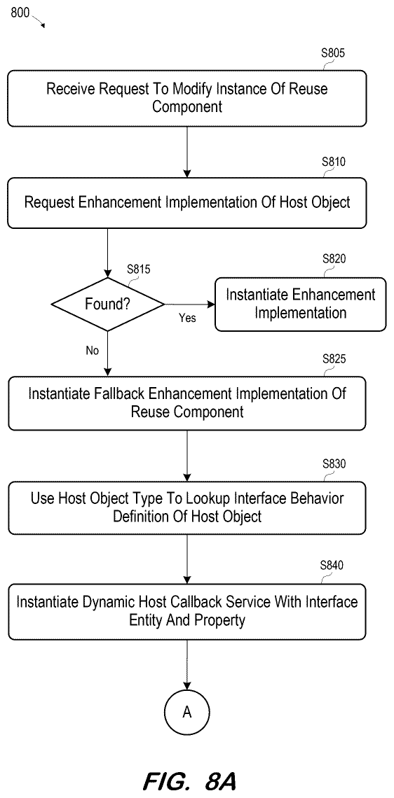

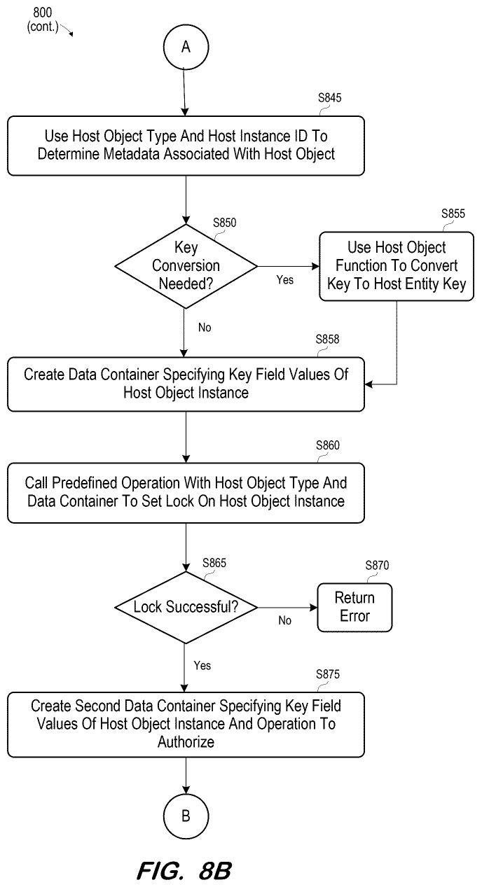

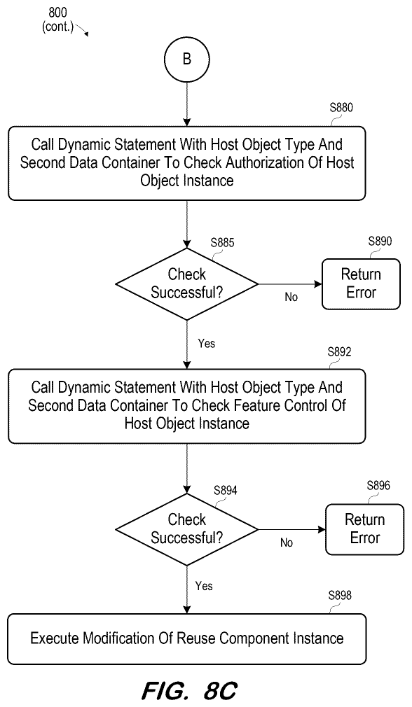

FIGS. 8A-8C comprise a flow diagram of process 800 to execute a fallback enhancement implementation utilizing dynamic host callbacks according to some embodiments. Process 800 and the other processes described herein may be performed using any suitable combination of hardware and software. Program code embodying these processes may be stored by any non-transitory tangible medium, including a fixed disk, a volatile or non-volatile random-access memory, a DVD, a Flash drive, or a magnetic tape, and executed by any one or more processing units, including but not limited to a processor, a processor core, and a processor thread. Embodiments are not limited to the examples described below.

Initially, at S805, a request to modify an instance of a reuse component is received. The instance of the reuse component to be modified is associated with an instance of a host object as described above. The request may be received from a user via a UI component provided by the reuse component. In one example of S805, a user manipulates UI component 214 of UI 200 to request deletion of an attachment which is currently associated with SupplierInvoice object instance SI223RE33, and the request is received by an application which provides UI 200.

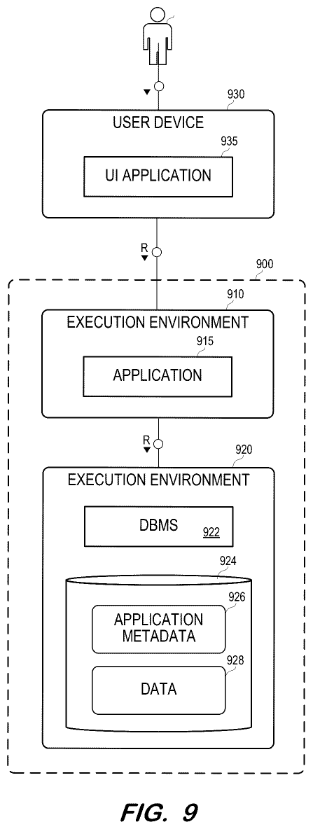

FIG. 9 is a block diagram of a computing system providing an application implementing reuse components and fallback enhancement implementations according to some embodiments. Each of the illustrated elements may be implemented using any suitable combination of on-premise, cloud-based, distributed (e.g., including distributed storage and/or compute nodes) computing hardware and/or software that is or becomes known.

Two or more elements of FIG. 9 may be co-located. In some embodiments, two or more components are implemented by a single computing device. One or more components may be implemented as a cloud service (e.g., Software-as-a-Service, Platform-as-a-Service). A cloud-based implementation of any components of FIG. 9 may apportion computing resources elastically according to demand, need, price, and/or any other metric.

Application system 900 includes execution environments 910 and 920. The execution environments of FIG. 9 may comprise one or more servers, virtual machines, clusters of a container orchestration system, etc. and may provide an operating system, services, I/O, storage, libraries, frameworks, etc. to applications or services executing therein, including applications/services which are not depicted in FIG. 9.

Application 915 executes within execution environment 910 to provide functionality to users based on its logic and on data stored in execution environment 920. Execution environment 920 executes database management system (DBMS) 922 to provide database functionality to application 915. Execution environment 920 includes data storage system 924 storing application metadata 926 and data 928. Data 928 may comprise row-stored data, column-stored data, object data, or data organized in any other matter. Data storage system 924 may comprise any one or more types of data storage media.

Metadata 926 defines the structure, organization, and other characteristics of the data 928. Application 915 and DBMS 922 operate based on objects defined in application metadata 926. Metadata 926 may define a schema including object names, object associations, field names, field data types, field constraints (e.g., primary key, foreign key), views, and indices. Metadata 926 may comprise several different repositories storing such metadata.

Returning to process 800, in response to the request received at S805 to perform lock/authorization, the reuse service will request an enhancement implementation for the host object. A kernel service then checks if the system includes an enhancement implementation for the host object. If such an artifact is found in the system, flow proceeds through S815 to S820 to instantiate the implementation and checks if the host object instance proceed as described above using the Lock, Check Authorization, and Check Feature Control implementations of the host object.

If an enhancement implementation for the host object is not found, the fallback implementation (i.e., class) of the reuse component is instantiated at S825. At S830, the type of the host object is used to lookup an interface behavior definition of the host object. For example, S830 may comprise accessing a repository including metadata 500 and determining an interface behavior definition of “I_SupplierConfirmationTP” for the host object type “SupplierConfirmation” based on metadata 500.

The instantiated fallback class then instantiates a dynamic host callback service at S840 with two properties: the interface entity of the reuse component and the reuse component property. Referring to the example of FIG. 6, the interface entity of the reuse component is identified as “I_NoteBasicTP” from metadata 610 and the reuse component property which stores the identifier of its host instance is identified as “NoteBasic. NoteBasicObject”. Next, at S845, the instantiated dynamic host callback service uses the host object type and a host instance identifier to retrieve metadata associated with the host object from one or more metadata repositories. Retrieval of the metadata may require a chain of calls in which metadata returned from one repository is used to query another repository.

As described with respect to metadata 700, the metadata may indicate whether the host instance identifier stored by the reuse component requires conversion to an entity key. If so, flow proceeds from S850 to S855 to convert the host instance identifier to a host entity key using host object functions specified in the metadata determined at S845. Flow then continues to S858. Flow also proceeds directly to S858 from S850 if it is determined at S850 that no key conversion is needed.

At S858, a data container specifying the key field values of the host object instance is created. To create the data container, data types of the key fields are determined from the entity metadata of the host object and the container is created with these data types. Next, at S860, the dynamic host callback service calls a predefined operation with the host object name and the data container to set a lock on the host object instance. According to some examples, the dynamic statement is an Entity Manipulation Language (EML) statement. EML is a declarative programming language designed for working with an object processing framework in the context of a particular programming model. EML provides a set of predefined operations to interact with object entities which conform to the particular programming model. In the present example, the predefined operation called at S860 is a SET LOCKS operation with which is passed the host object name and the data container (which includes the host entity key).

At S865, it is determined if the lock is successful. If not, an error is returned to the reuse component at S870. The reuse component processes the error according to its specific logic. Flow proceeds to S875 if the lock on the host object instance is successful.

At S875, a second data container specifying the key field values of the host object instance and the operation to be authorized is created. In the present embodiment, the operation to be authorized is an “Update” operation. A dynamic statement is called with the host object name and the second data container at S880 to check the authorization of the host object instance. In some embodiments, the dynamic statement is a GET PERMISSIONS FORWARDING PRIVILEGED ONLY AUTHORIZATION OPERATIONS statement.

If the authorization check is determined to be unsuccessful at S885, an error is returned at S890. If the authorization check is determined to be successful (i.e., the user is authorized to make changes to the host object instance), a dynamic statement is called with the host object name and the second data container at S892 to check the feature control of the host object instance. In some embodiments, the dynamic statement called at S892 is a GET PERMISSIONS FORWARDING PRIVILEGED ONLY FEATURES OPERATIONS statement.

At S894, it is determined whether the feature control check was successful. If not, an error is returned at S896. If the feature control check was successful, the reuse component executes the requested modification. It should be noted that the reuse component may execute its own authorization, feature control or other checks when executing the modification at S898.

The foregoing diagrams represent logical architectures for describing processes according to some embodiments, and actual implementations may include more, or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation some embodiments may include a processing unit to execute program code such that the computing device operates as described herein.

Embodiments described herein are solely for the purpose of illustration. Those in the art will recognize other embodiments may be practiced with modifications and alterations to that described above.

What is claimed is:

1. A system comprising:
a memory storing program code; and
one or more processing units to execute the program code to cause the system to:
receive a request to modify an instance of a reuse component; and
in response to the request, instantiate a class of the reuse component to:
determine an interface behavior definition of a host object of the instance of the reuse component based on a type of the host object; and
instantiate a dynamic host callback service with an interface entity of the reuse component and property of the reuse component which stores an identifier of a host object instance of the instance of the reuse component to:
determine metadata associated with the host object based on the type of the host object and the identifier of the host object instance;
call a first predefined operation with the type of the host object and the identifier of the host object instance to set a lock on the host object instance;
determine data types of key fields of the host object based on the metadata;
create a data container of key field values of the host object instance based on the determined data types; and
call a second predefined operation with the type of the host object and the data container to check an authorization to modify the host object instance.

2. The system according to claim 1, the one or more processing units to execute the program code to cause the system to instantiate the dynamic host callback service with the interface entity and the property of the reuse component to:
determine, based on the metadata, to convert the identifier of the host object instance to a host entity key;
determine a conversion function based on the metadata; and
execute the conversion function to convert the identifier of the host object instance to a host entity key.

3. The system according to claim 2, the one or more processing units to execute the program code to cause the system to instantiate the dynamic host callback service with the interface entity and the property of the reuse component to:
call a third predefined operation with the type of the host object and the data container to check a feature control of the host object instance.

4. The system according to claim 1, the one or more processing units to execute the program code to cause the system to instantiate the dynamic host callback service with the interface entity and the property of the reuse component to:
call a third predefined operation with the type of the host object and the data container to check a feature control of the host object instance.

5. The system according to claim 1, the one or more processing units to execute the program code to cause the system to:
receive a second request to modify a second instance of the reuse component; and
in response to the second request, instantiate the class of the reuse component to:
determine a second interface behavior definition of a second host object of the second instance of the reuse component based on a second type of the second host object; and
instantiate the dynamic host callback service with the second interface entity of the reuse component and a property of the reuse component which stores a second identifier of a second host object instance of the second instance of the reuse component to:
determine second metadata associated with the second host object based on the second type of the second host object and the second identifier of the second host object instance;
call the first predefined operation with the second type of the second host object and the second identifier of the second host object instance to set a second lock on the second host object instance;
determine second data types of second key fields of the second host object based on the second metadata;
create a second data container of second key field values of the second host object instance based on the determined second data types; and
call the second predefined operation with the second type of the second host object and the second data container to check a second authorization to modify the second host object instance.

6. The system according to claim 5, the one or more processing units to execute the program code to cause the system to instantiate the dynamic host callback service with the interface entity and the property of the reuse component to:
determine, based on the metadata, to convert the identifier of the host object instance to a host entity key;
determine a conversion function based on the metadata;
execute the conversion function to convert the identifier of the host object instance to a host entity key; and
call a third predefined operation with the type of the host object and the data container to check a feature control of the host object instance.

7. The system according to claim 1, the one or more processing units to execute the program code to cause the system to:
receive a second request to modify a second instance of a second reuse component; and
in response to the second request, instantiate a second class of the second reuse component to:
determine the interface behavior definition of the host object of the second instance of the second reuse component based on the type of the host object; and
instantiate the dynamic host callback service with a second interface entity of the second reuse component and a second property of the second reuse component which stores an identifier of the host object instance of the second instance of the second reuse component to:
determine the metadata associated with the host object based on the type of the host object and the identifier of the host object instance;
call the first predefined operation with the type of the host object and the identifier of the host object instance to set a second lock on the host object instance;
determine the data types of the key fields of the host object based on the metadata;
create a second data container of the key field values of the host object instance based on the determined data types; and
call a second predefined operation with the type of the host object and the data container to check an authorization to modify the host object instance.

8. A method comprising:
receiving a request to modify an instance of a reuse component; and
in response to the request, instantiating a class of the reuse component to:
determine an interface behavior definition of a host object of the instance of the reuse component based on a type of the host object;
determine an interface entity of the reuse component and a property of the reuse component which stores an identifier of a host object instance of the instance of the reuse component; and
instantiate a dynamic host callback service with an interface entity of the reuse component and a property of the reuse component which stores an identifier of a host object instance of the instance of the reuse component to:
determine metadata associated with the host object based on the type of the host object and the identifier of the host object instance;
call a first predefined operation with the type of the host object and the identifier of the host object instance to set a lock on the host object instance;
determine data types of key fields of the host object based on the metadata;
create a data container of key field values of the host object instance based on the determined data types; and
call a second predefined operation with the type of the host object and the data container to check an authorization to modify the host object instance.

9. The method according to claim 8, the dynamic host callback service with the interface entity and the property of the reuse component to:
determine, based on the metadata, to convert the identifier of the host object instance to a host entity key;
determine a conversion function based on the metadata; and
execute the conversion function to convert the identifier of the host object instance to a host entity key.

10. The method according to claim 9, the dynamic host callback service with the interface entity and the property of the reuse component to:
call a third predefined operation with the type of the host object and the data container to check a feature control of the host object instance.

11. The method according to claim 8, the dynamic host callback service with the interface entity and the property of the reuse component to:
call a third predefined operation with the type of the host object and the data container to check a feature control of the host object instance.

12. The method according to claim 8, further comprising:
receiving a second request to modify a second instance of the reuse component; and
in response to the second request, instantiating the class of the reuse component to:
determine a second interface behavior definition of a second host object of the second instance of the reuse component based on a second type of the second host object; and
instantiate the dynamic host callback service with a second interface entity of the reuse component and the property of the reuse component which stores a second identifier of a second host object instance of the second instance of the reuse component to:
determine second metadata associated with the second host object based on the second type of the second host object and the second identifier of the second host object instance;
call the first predefined operation with the second type of the second host object and the second identifier of the second host object instance to set a second lock on the second host object instance;
determine second data types of second key fields of the second host object based on the second metadata;
create a second data container of second key field values of the second host object instance based on the determined second data types; and
call the second predefined operation with the second type of the second host object and the second data container to check a second authorization to modify the second host object instance.

13. The method according to claim 12, the dynamic host callback service with the interface entity and the property of the reuse component to:
determine, based on the metadata, to convert the identifier of the host object instance to a host entity key;
determine a conversion function based on the metadata;
execute the conversion function to convert the identifier of the host object instance to a host entity key; and
call a third predefined operation with the type of the host object and the data container to check a feature control of the host object instance.

14. The method according to claim 8, further comprising:
receiving a second request to modify a second instance of a second reuse component; and
in response to the second request, instantiating a second class of the second reuse component to:
determine the interface behavior definition of the host object of the second instance of the second reuse component based on the type of the host object; and
instantiate the dynamic host callback service with a second interface entity of the second reuse component and a second property of the second reuse component which stores an identifier of the host object instance of the second instance of the second reuse component to:
determine the metadata associated with the host object based on the type of the host object and the identifier of the host object instance;
call the first predefined operation with the type of the host object and the identifier of the host object instance to set a second lock on the host object instance;
determine the data types of the key fields of the host object based on the metadata;
create a second data container of the key field values of the host object instance based on the determined data types; and
call a second predefined operation with the type of the host object and the data container to check an authorization to modify the host object instance.

15. One or more non-transitory media storing program code executable by one or more processing units of a computing system to cause the computing system to:
receive a request to modify an instance of a reuse component; and
in response to the request, instantiate a class of the reuse component to:
determine an interface behavior definition of a host object of the instance of the reuse component based on a type of the host object; and
instantiate a dynamic host callback service with an interface entity of the reuse component and a property of the reuse component which stores an identifier of a host object instance of the instance of the reuse component to:
determine metadata associated with the host object based on the type of the host object and the identifier of the host object instance;
call a first predefined operation with the type of the host object and the identifier of the host object instance to set a lock on the host object instance;
determine data types of key fields of the host object based on the metadata;
create a data container of key field values of the host object instance based on the determined data types; and
call a second predefined operation with the type of the host object and the data container to check an authorization to modify the host object instance.

16. The one or more non-transitory media of claim 15, the program code executable by one or more processing units of a computing system to cause the computing system to instantiate the dynamic host callback service with the interface entity and the property of the reuse component to:
determine, based on the metadata, to convert the identifier of the host object instance to a host entity key;
determine a conversion function based on the metadata; and
execute the conversion function to convert the identifier of the host object instance to a host entity key.

17. The one or more non-transitory media of claim 16, the program code executable by one or more processing units of a computing system to cause the computing system to instantiate the dynamic host callback service with the interface entity and the property of the reuse component to:
call a third predefined operation with the type of the host object and the data container to check a feature control of the host object instance.

18. The one or more non-transitory media of claim 15, the program code executable by one or more processing units of a computing system to cause the computing system to instantiate the dynamic host callback service with the interface entity and the property of the reuse component to:
call a third predefined operation with the type of the host object and the data container to check a feature control of the host object instance.

19. The one or more non-transitory media of claim 15, the program code executable by one or more processing units of a computing system to cause the computing system to:
receive a second request to modify a second instance of the reuse component; and
in response to the second request, instantiate the class of the reuse component to:
determine a second interface behavior definition of a second host object of the second instance of the reuse component based on a second type of the second host object; and
instantiate the dynamic host callback service with a second interface entity of the reuse component and the property of the reuse component which stores a second identifier of a second host object instance of the second instance of the reuse component to:
determine second metadata associated with the second host object based on the second type of the second host object and the second identifier of the second host object instance;
call the first predefined operation with the second type of the second host object and the second identifier of the second host object instance to set a second lock on the second host object instance;
determine second data types of second key fields of the second host object based on the second metadata;
create a second data container of second key field values of the second host object instance based on the determined second data types; and
call the second predefined operation with the second type of the second host object and the second data container to check a second authorization to modify the second host object instance.

20. The one or more non-transitory media of claim 19, the program code executable by one or more processing units of a computing system to cause the computing system to instantiate the dynamic host callback service with the interface entity and the property of the reuse component to:
determine, based on the metadata, to convert the identifier of the host object instance to a host entity key;
determine a conversion function based on the metadata;
execute the conversion function to convert the identifier of the host object instance to a host entity key; and
call a third predefined operation with the type of the host object and the data container to check a feature control of the host object instance.
